(19) United States
(12) Patent Application Publication
(10) Pub. No.: US 2005/0052659 A1
(43) Pub. Date: Mar. 10, 2005

(54) Progress indicator for graphical display on printers

(76) Inventors: Dana A. Jacobsen, Boise, ID (US); Terry-Lee M. Fritz, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/655,775

(22) Filed: Sep. 5, 2003

(51) Int. Cl. G06F 15/00

(52) U.S. Cl. 358/1.1

(57) ABSTRACT

According to one embodiment, a printer display includes a control system to monitor progress in processing a print job. A progress indicator is configured to display progress information to indicate the progress in processing the print job.

### BACKGROUND

Printers typically have a small display panel and/or color emitting lights that provide status information while a printer is processing a print job. In most higher-end printers the display panel provides a minimal amount of status information describing the state of the printer. Such status information can usually be displayed to a user on the display panel in one-to-two words, such as, “Ready,” “Paper Jam,” “Processing Job,” etc. Under favorable circumstances, a user is able to view such status information and determine if there is a problem with the printer.

Such status information is insufficient to inform the user accurately of the printer's status. For example, a printer may process a print job wherein some pages require long periods of time for processing before being printed. Accordingly, a user may not observe any printer activity for a long period of time.

During these significant delays, static status information which is graphically displayed to a user can create a false assumption that the printer has malfunctioned. Thus, users are often frustrated by the current lack of status information provided by printers.

### SUMMARY

According to one embodiment, a printer display includes a control system to monitor progress in processing a print job. A progress indicator is configured to display progress information to indicate the progress in processing the print job.

### BRIEF DESCRIPTION OF THE DRAWINGS

The detailed description is described with reference to the accompanying figures. In the figures, the left-most digit(s) of a reference number identifies the figure in which the reference number first appears.

FIG. 1 illustrates various components of an exemplary printer that can be utilized to implement the inventive techniques described herein.

FIG. 2 is a block diagram illustrating a more detailed exemplary version of a display panel that may be incorporated with a printer. FIGS. 3, 4 and 5 illustrate various examples of the types of graphical representations that may be displayed on a progress indicator of the display panel.

FIG. 6 is a flowchart illustrating an exemplary process for displaying a progress indicator on the display panel of a printer.

### DETAILED DESCRIPTION

The following description introduces the concept of providing a progress indicator on a display panel of a printer that provides a graphical representation indicative of the degree to which a print job has been processed by the printer.

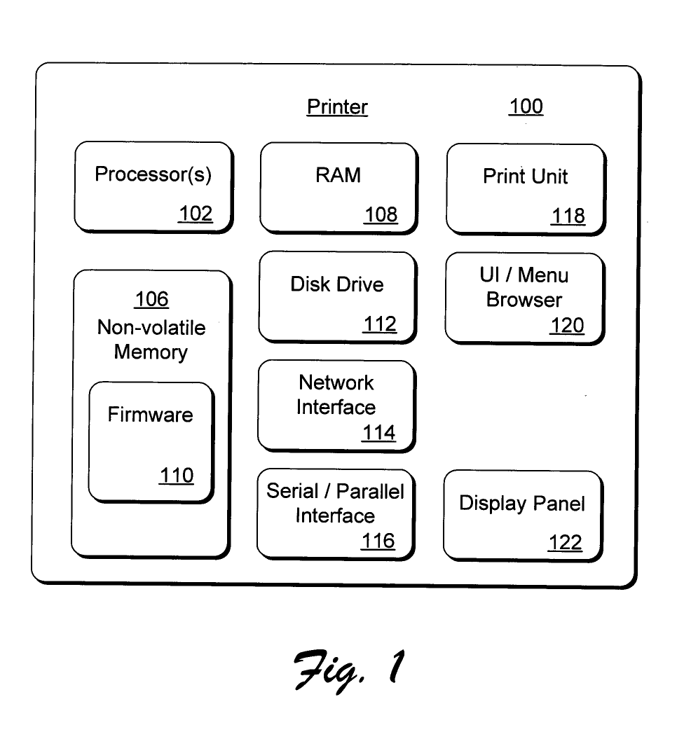

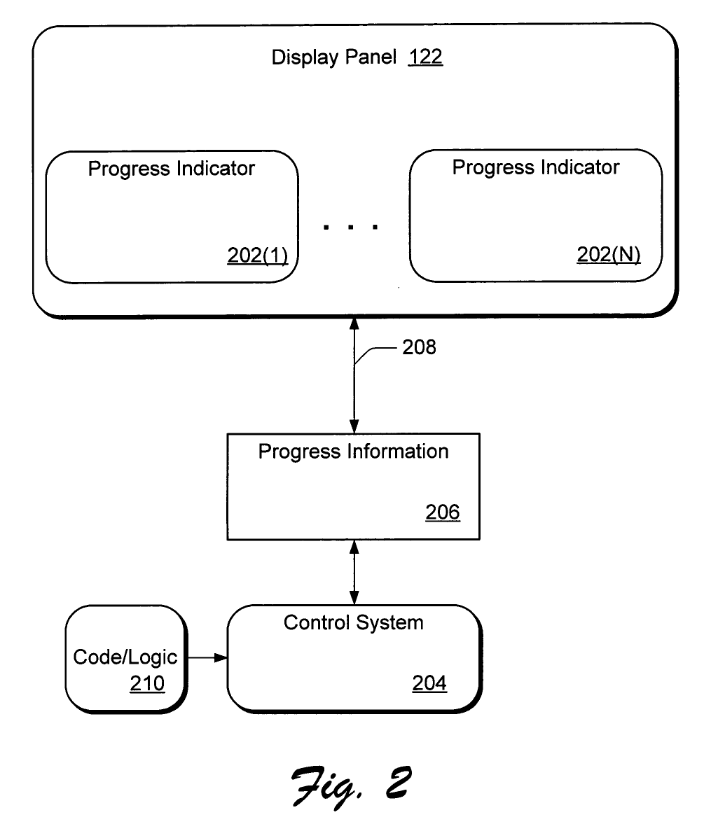

FIG. 1 illustrates various components of an exemplary printer 100 that can be utilized to implement the inventive techniques described herein. Printer 100 includes one or more processors 102, a non-volatile memory 106, and a random access memory (RAM) 108. Non-volatile memory 106 can include one or more of the following, in combination or in the alternative: read only memory (ROM), electrically erasable programmable read only memory (EEPROM), removable or non-removable compact flash, or any other implementation of non-volatile memory. Additionally, although not shown, a system bus typically connects the various components within printing device 100.

Printer 100 may include a firmware component 110 that is implemented as a permanent memory module stored in non-volatile memory 106. Firmware 110 may be programmed and tested like software, and may be distributed with printer 100 or distributed as an upgrade. Firmware 110 can be implemented to coordinate operations of the hardware within printer 100 and may contain programming constructs used to perform such operations.

Processor(s) 102 process various instructions to control the operation of the printer 100 and to communicate with other electronic and computing devices. The memory components, non-volatile memory 106, and RAM 108, store various information and/or data such as configuration information, fonts, templates, data being printed, and menu structure information.

Printer 100 may also include a disk drive 112, a network interface 114, and a serial/parallel interface 116. Disk drive 112 provides additional storage for data being printed or other information maintained by printer 100. Although printer 100 is illustrated having both RAM 108 and a disk drive 112, a particular printer may include either RAM 108 or disk drive 112, depending on the storage needs of the printer. For example, an inexpensive printer may include a small amount of RAM 108 and no disk drive 112, thereby reducing the manufacturing cost of the printer.

Network interface 114 provides a connection between printer 100 and a data communication network. Network interface 114 allows devices coupled to a common data communication network to send print jobs, menu data, and other information to printer 100 via the network. Similarly, serial/parallel interface 116 provides a data communication path directly between printer 100 and another electronic or computing device. Although printer 100 is illustrated having a network interface 114 and serial/parallel interface 116, a particular printer may only include one interface component. Other interfaces such as a Universal Serial Bus (USB), Institute of Electrical and Electronics Engineers (IEEE) 1394 data transport bus (also referred to as “Fire-wire”), Radio Frequency, optical transmission, magnetic induction, and the like are also possible.

Printer 100 also includes a print unit 118 that includes mechanisms arranged to selectively apply an imaging medium such as liquid ink, toner, and the like to a print media in accordance with print data corresponding to a print job. Print media can include any form of media used for printing such as paper, plastic, fabric, Mylar, transparencies, and the like, and different sizes and types such as 8½×11, A4, roll feed media, etc. For example, print unit 118 can include an inkjet printing mechanism that selectively causes ink to be applied to a print media in a controlled fashion. The ink on the print media can then be more permanently fixed to the print media, for example, by selectively applying conductive or radiant thermal energy to the ink. Those skilled in the art will recognize that there are many different types of print units available, and that for the purposes of this discussion, print unit 118 can include any of these different types.

Printer 100 also includes a user interface and menu browser 120, and a display panel 122. The user interface and menu browser 120 allows a user of the printer 100 to navigate the printer's menu structure. User interface 120 can be indicators or a series of buttons, switches, touch-screen, or other selectable controls that are manipulated by a user of the printer. Display panel 122 is a graphical display that provides information regarding the status of printer 100 and the current options available to a user through the menu structure.

General reference is made herein to one or more printing devices, such as printer 100. As used herein, “printer” means any electronic device having data communications, data storage capabilities, and/or functions to render or process printed characters and images on a print media. A printer may be a fax machine, copier, plotter, and includes any type of printing device using a transferred imaging medium, such as ejected ink, to create an image on a print media. Examples of such a printer can include, but are not limited to, laser printers, inkjet printers, plotters, portable printing devices, as well as multi-function combination devices. Although specific examples may refer to one or more of these printers, such examples are not meant to limit the scope of the claims or the description, but are meant to provide a specific understanding of the described implementations.

It is to be appreciated that additional components (not shown) can be included in printer 100 and some components illustrated in printer 100 above need not be included. For example, additional processors or storage devices, additional I/O interfaces, and so forth may be included in printer 100, or disk drive 112 may not be included.

It is also to be appreciated that the components and processes described herein can be implemented in software, firmware, hardware, or combinations thereof. By way of example, a programmable logic device (PLD) or application specific integrated circuit (ASIC) could be configured or designed to implement various components and/or processes discussed herein.

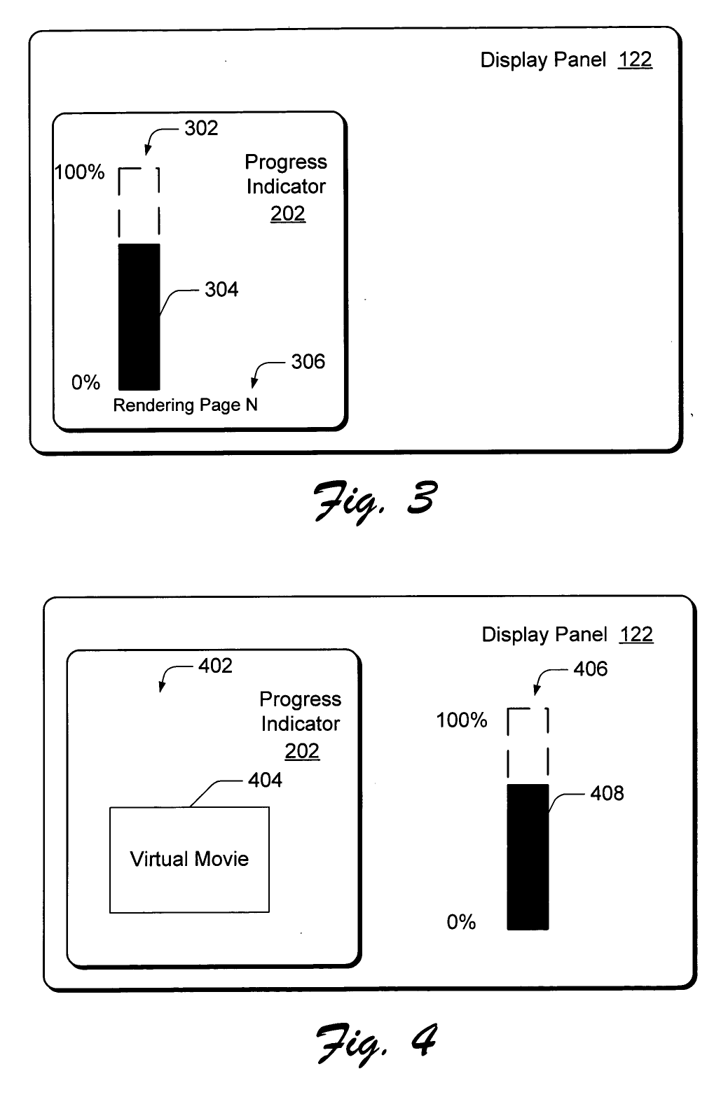

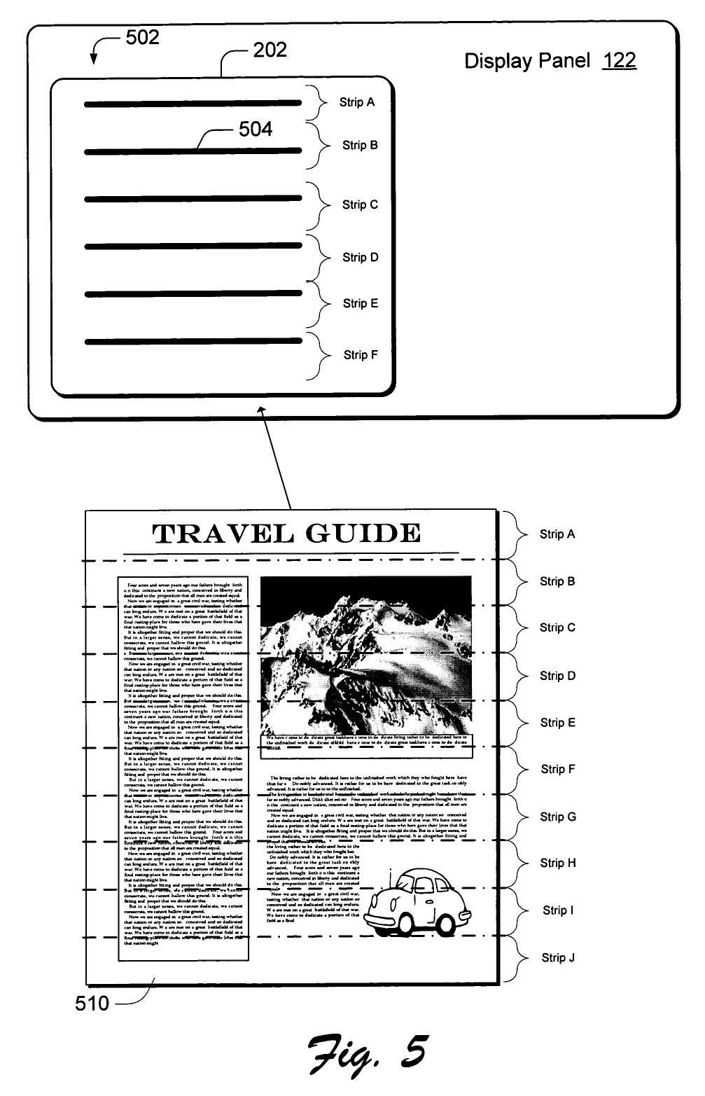

FIG. 2 is a block diagram illustrating a more detailed exemplary version of display panel 122 that may be incorporated with printer 100. As mentioned above, display panel 122 is a display device used to provide visual status information about the printer 100 and potential display/input control capabilities. Display panel 122 may include any of a variety of conventional display devices, such as an LED screen, a color or monochrome LCD screen, a touch-screen, and so forth. One or more buttons or keys (not shown), cursor control devices (e.g., a trackball, track pad, directional keys, etc. not shown) can be included as part of the display panel 122. Such various components allow a local user of printer 100 (e.g., a user standing at printer 100 rather than accessing printer 100 via a network or host device) to interact with printer 100 and view status information about printer 100 provided by display panel 122. The display panel 122 shown in FIG. 2 is exemplary only and the exact quantity of components and design of the display panel 122 included in any particular printer 100 can vary.

Included within a portion of display panel 122 are one or more progress indicators 202(1), . . . , 202(N). A progress indicator, referenced generally as number 202, is a visual area on the display panel 122 large enough to be observed by a user that provides a graphical representation indicative of a degree to which a print job has been processed by a printer. This graphical representation allows a user to ascertain the progress of a print job request as the print job is being processed by printer 100. For example, a single progress indicator 202(1) is deployed; it can illustrate job level status. Alternatively, if more than one progress indicator is implemented in the display area, each progress indicator may display particular information associated with progress of the print job. For example, if two progress indicators are deployed, one progress indicator may provide overall job progress and the other indicator may show the status of how far along a particular page is being processed by the printer 100.

In one exemplary implementation, a single progress indicator 202 is a window of approximately 100×100 pixels, however, it is envisioned that the progress indicator 202 could be larger or smaller depending on the size of the display panel 122, the type of each progress indicator 202, and the number of progress indicators. Additionally, progress indicator 202 could be adjustable in size.

Progress indicator 202 is controlled by a control system 204. Control system 204 includes processor(s) 102, such as a general purpose processor or one or more dedicated microcontrollers (e.g., one or more ASICs or PLDs). Also included in control system 204 is processor code 210 (in the form of logic or computer coded instructions) stored on some type of processor-readable medium, such as non-volatile memory 106 and/or as firmware 110 shown in FIG. 1.

Control system 204 monitors a degree to which the printer 100 has processed a print job from a time when the printer 100 initiates processing of the print job until a time when printer 100 completes processing of the print job. Based on this monitoring of the processing of a print job request, control system 204 generates progress information 206. The progress information 206 is received by the display panel 122 in the form of a control signal 208 and then displayed by the display panel 122 within progress indicator 202. Exemplary methods by which control system 204 can determine progress information 206 are described below.

FIGS. 3, 4 and 5 illustrate various examples of the types of graphical representations that may be displayed—individually or in combination—on a progress indicator 202 of the display panel 122. FIG. 3 shows a graphical representation 302 of a progress bar 304 that moves from zero to one hundred percent at the beginning and end of each page rendered or processed by printer 100. As the page is completely processed or rendered, the progress bar 304 goes from one hundred percent back to zero percent and restarts growing (i.e., progressing) until the progress bar reaches one hundred percent again indicating that the page has been completely processed or rendered. Each time a new page appears on the progress indicator 202, the page number 306 can be displayed providing the user with an indication of how far along the print job has been processed. In many cases the total number of pages in a job is not known, in which case the single page number “N” as shown in 306 is displayed. In other cases the total number of pages in a job is known at the start of the job (typically inserted by the print driver), and the display can now be “N of M” or “N/M” where M is the total number of pages in the job and N is the current page number being processed.

FIG. 4 shows a graphical representation 402 that includes a virtual movie 404 showing the printer 100 process one or more pages of the print job request from a time the printer initiates processing the page(s) to a time when the printer completes processing the page(s). The virtual movie 404 could be detailed or extremely simple. It is envisioned that a detailed virtual movie would show printable media traveling through the various components of a printer 100 starting from an input tray (not shown) to ending at output bin (not shown). A virtual movie can show images being processed on a page until the page is fully processed at which time the page could be erased representing the start of a new page to be processed.

A progress indicator 406 associated with the entire print job may optionally be included within the display panel 122. Accordingly, the graphical representation 402 would indicate the progress of an individual page, while the progress indicator 406 would indicate progress of the entire print job. In the example illustrated, indicator 408 implies that over half of the print job has been printed.

FIG. 5 shows a progress indicator 202 illustrating a virtual page 502 including a strip-by-strip graphical or virtual representation, such as a thumbnail view or image that corresponds to a page 510 as it is processed on a strip-by-strip basis by printer 100. Thus, the thumbnail image 502 is incrementally updated as the page 510 is processed, and the virtual page 502 shows what the page being printed will look like, typically in much reduced detail and resolution. Each strip (A-J) is a subset of page 510, such as a horizontal or vertical slice of the page. As each strip (A-J) is processed (e.g., strip A, then strip B, and so forth) the progress indicator 202 will enable a virtual strip (strip A, strip B, and so forth) in the form of a graphical bar 504 (or a graphical representation of the actual strip to be printed) to be illuminated across virtual page 502 within the progress indicator 202. Each time a virtual strip is illuminated, it represents that a particular strip (A-J) of page 510 has been processed by printer 100. Eventually, at completion of processing page 510, the progress indicator 202 will show strips A-J. The graphical representation will then be erased from the progress indicator 202 and the process repeats. While the example given uses strips, any other suitable tiling of the page used by the printer can be used. Where the graphical bar 504 is configured to be a graphical representation of a strip being printed, a thumbnail image is produced during the printing process. In this case, not only is there a clear indication that a page is indeed being processed, but there is also an indication of what the page is actually going to look like once the page is printed (e.g., “Travel Guide” representing Strip A and displayed as the first bar 504 associated with Strip A on the progress indicator 202).

Accordingly, control system 204 monitors the progress of an entire print job, including monitoring the progress of each page of the print job. In particular, the control system monitors the printer 100 as it initiates processing of one or more images on a strip (e.g. A, B, or C etc.) of a page, and continues to monitor until a time wherein the printer completes processing the strip. The display panel 122 via progress indicator 202 receives this information from the control system 204 and displays a graphical representation (e.g. virtual page 502) showing progress of when the printer 100 completes processing a page 510.

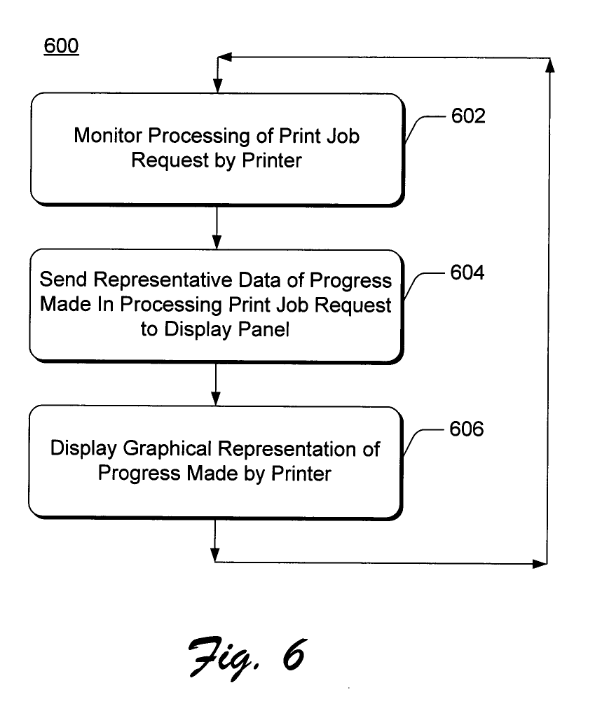

FIG. 6 is a flowchart illustrating an exemplary process 600 for displaying a progress indicator 202 on a display panel 122 of a printer 100. Process 600 may be performed in software, firmware, hardware, or combinations thereof, and may be embodied in the form of a computer- or processor-readable medium. As used herein, the phrase computer- or processor-readable media or medium can refer to any medium that can contain, store or propagate computer executable instructions. Thus, in this document, the phrase computer- or processor readable medium may refer to a medium such as an optical storage device (e.g., a CD ROM), a solid state memory device such as RAM or ROM, a magnetic storage device (e.g., a magnetic tape), or memory or media of other technology. The phrase computer- or processor-readable medium or media may also refer to signals that are used to propagate the computer executable instructions over a network or a network system, such as an intranet, the World Wide Web, the Internet or similar network.

Initially, at a block 602, control system 204 tracks the progress of printable images processed by printer 100. When printer 100 receives a print job, typically in some Page Description Language (PDL), the print job is parsed into commands which are split into strips (for example associated with strips A-J shown in FIG. 5). These commands are then stored in a display list (not shown) for each strip.

At a block 604, control system 204 sends data, providing a snapshot of the progress made by printer 100 in processing (such as processing) printable images associated with a print job request, to the display panel 122. Processing may include parsing the display list commands described above with reference to block 602 and producing a bitmap at the chosen resolution for the printer. It should be noted that there are many ways in which to determine the progress made in processing a print job. One technique to obtain progress information involves tracking how many strips are processed. For example, if there are 50 equal sized strips per page and each strip that is processed corresponds to two percent of the page, then it is possible to determine progress on a strip-by-strip basis.

Another technique to obtain progress information involves monitoring memory usage. For purposes of discussion, suppose that a page uses 10 MB of intermediate storage. Accordingly, as each 100k is processed (or rendered), then it can be deduced that at least one percent of the print job has been processed. Similarly, memory usage could be used for measuring a rate at which entire print jobs are completed, and for obtaining progress information related to individual pages or the entire print job. For example, memory initially required could be compared to memory currently required to obtain progress information.

An alternative technique to obtain progress information can be calculated by estimating process times to predict remaining time for a print job. For example, suppose that for each strip N, t(n) represents the estimated process time, then the total estimated page time is Σt(n) and it is possible to determine the percentage of a job completed in after any strip has been processed. Thus, from the foregoing examples, it is possible to provide an accurate percentage of how far along the printer has processed a print job from a time when the printer initiates processing a print job until a time when the printer completes the print job. Accordingly, processing time required for part of the print job may be measured, and an estimation made for the processing time for the remainder of the job may be based on the measured time. Additionally, or alternatively, the rate at which progress is being made on a print job (or other measurement tool) may be used to derive an estimated time remaining until completion of the print job. This may be expressed in terms of minutes and seconds; e.g. the progress indicator may indicate that “the print job will be completed in mm:ss”.

At a block 606, the display panel 122, via a progress indicator 202 (under control of control system 204), displays a graphical representation of the progress made by printer 100 in processing the print job request. The operations performed in process 600 are repeated until the print job request is fully processed (e.g., fully rendered).

The graphical representation and the type of information displayed by the progress indicator 202 can vary as described with reference FIGS. 3, 4, and 5. Additionally, the graphical representation can include different levels of granularity from strips to one or more sequences of pages as they are processed. Furthermore, the graphical representations can vary and are not necessarily limited to the exemplary illustrations shown in FIGS. 3, 4 and 5. For extremely small print job requests, those that can be processed and printed extremely quickly, the control system 204 can forgo generating the progress indicator 202 on the display panel 122.

Thus, although preferred implementations of the various methods and arrangements of the present invention have been illustrated in the accompanying Drawings and described in the foregoing Detailed Description, it will be understood that the invention is not limited to the exemplary aspects disclosed, but is capable of numerous rearrangements, modifications and substitutions without departing from the spirit of the invention as set forth and defined by the following claims. For example, while progress indicators associated with the output of a single page of a print job have been described, and progress indicators associated with the entire print job have been described, it is clear that different embodiments of each could be mixed, matched and varied to achieve a desired result.

1. A printer display, comprising:
a control system to monitor progress in processing a print job; and
a progress indicator to display progress information to indicate the progress in processing the print job.

2. The display of claim 1, wherein the progress information that the progress indicator displays includes a page number currently being processed.

3. The display of claim 1, wherein the progress indicator comprises a progress bar configured to move from zero to one hundred percent at a beginning and at an end of each page processed, respectively.

4. The display of claim 1, wherein the progress indicator additionally comprises a progress bar configured to move from zero to one hundred percent at a beginning and at an end of the print job, respectively.

5. The display of claim 1, wherein the control system is configured to monitor the progress by monitoring memory initially required for the print job and memory currently required for the print job.

6. The display of claim 1, wherein the control system is configured to monitor the progress by measuring processing time required for completion of part of the print job and estimating remaining processing time for the print job.

7. The display of claim 1, wherein the progress indicator is configured to indicate estimated remaining processing time in mm:ss notation.

8. The display of claim 1, wherein the progress information comprises a virtual movie showing a printer processing a page of the print job from a time the printer initiates processing the page to a time when the printer completes processing the page.

9. The display of claim 1, wherein the progress indicator comprises a virtual page associated with a page of the print job.

10. The display of claim 9, wherein the virtual page is illuminated strip by strip, as each strips within an actual page within the print job are processed.

11. The display of claim 1, wherein the progress information comprises:
information on progress of a current page being processed; and
information on progress of the print job.

12. A printer, comprising:
a print unit;
a display panel;
a processor and associated memory operatively coupled to the print unit and the display panel, wherein the processor is configured to direct the display panel to display progress information indicative of progress of a print job from initiation to completion.

13. The printer as recited in claim 12, wherein the processor is configured to generate the progress information using a technique selected from a group of techniques comprising:
determining a number of strips processed in view of a number of strips to be processed;
monitoring memory use to determine the progress information; and
estimating processing times to predict remaining time for the print job.

14. The printer as recited in claim 12, additionally comprising:
a control system configured to monitor time passage from a time the printer initiates processing one or more images to a time when the printer completes processing the one or more images.

15. The printer as recited in claim 14, wherein the control system is further configured to monitor a time the printer initiates processing a strip and a time the printer completes processing the strip.

16. The printer as recited in claim 14, wherein the control system is further configured to monitor a time the printer initiates processing a page and a time the printer completes processing the page.

17. The printer as recited in claim 12, additionally comprising:
a progress indicator configured to display on the display panel a graphical representation showing processing progress of each page of a print job and processing progress of the print job in its entirety.

18. A printer progress display system, comprising:
a display panel;
a control system configured to track progress of printable images as the printable images are processed; and
a progress indicator configured to display a graphical representation of the progress on the display panel.

19. The system of claim 18, wherein the progress indicator is configured to provide a strip-by-strip graphical representation of printable images as the printable images are processed.

20. The system of claim 18, wherein the progress indicator is configured to display a page number corresponding to progress processing a print job.

21. The system of claim 18, wherein the progress indicator comprises a progress bar configured to move from zero to one hundred percent at a beginning and an end of each page processed, respectively.

22. The system of claim 18, wherein the graphical representation comprises a virtual movie configured to show a printer processing a page of a print job from a time the printer initiates processing the page to a time the printer completes processing the page.

23. The system of claim 18, wherein the progress indicator comprises a thumbnail image located within the display panel.

24. A method of printer progress display, comprising:
monitoring processing of strips on a page; and
displaying a graphical representation showing progress of the processing of the strips on the page.

25. The method as recited in claim 24, wherein the displaying comprises displaying a progress bar that moves as each page is processed from an initial value at a page beginning to a final value at a page ending.

26. The method as recited in claim 24, wherein the displaying comprises displaying a virtual movie showing a printer process a page of a print job from a time the printer initiates processing the page to a time when the printer completes processing the page.

27. The method as recited in claim 24, wherein the displaying comprises displaying a thumbnail image of the page.

28. A processor-readable medium comprising processor-executable instructions for:
operating a progress indicator on a display panel of a printer;
obtaining data on a degree to which progress has been made on a print job; and
providing, on the progress indicator, a graphical representation indicative of the progress made on the print job.

29. The processor-readable medium as recited in claim 28, comprising further instructions for:
generating a thumbnail image within a portion of the display panel to provide an indication of what a page of the print job is going to look like.

30. A processor-readable medium comprising processor-executable instructions for:
monitoring processing of strips on a page; and
displaying a graphical representation showing progress of the processing of the strips on the page.

31. The processor-readable medium as recited in claim 30, comprising further instructions for:
displaying a progress bar that moves as each page is processed from an initial value at a page beginning to a final value at a page ending.

32. The processor-readable medium as recited in claim 30, comprising further instructions for:
displaying a virtual movie showing a printer process a page of a print job from a time the printer initiates processing the page to a time when the printer completes processing the page.

33. The processor-readable medium as recited in claim 30, comprising further instructions for:
displaying a thumbnail image of the page; and
incrementally updating the thumbnail image as the page is processed.

34. A processor-readable medium comprising processor-executable instructions for:
operating a printer display to display progress information indicative of progress in processing of a print job; and
updating the display as the processing progresses toward completion of the print job.

35. The processor-readable medium as recited in claim 34, comprising further instructions for:
including a page number currently being processed within the progress information.

36. The processor-readable medium as recited in claim 34, comprising further instructions for:
incrementing a progress bar configured to move from zero to one hundred percent at a beginning and an end of each page processed, respectively.

37. The processor-readable medium as recited in claim 34, comprising further instructions for:
displaying a virtual movie showing a printer processing a page of the print job from a time the printer initiates processing the page to a time when the printer completes processing the page.

38. The processor-readable medium as recited in claim 34, comprising further instructions for:
displaying a thumbnail image associated with a page of the print job; and
incrementally altering the thumbnail image as the print job is processed.
